(19) United States
(12) Patent Application Publication
(10) Pub. No.: US 2018/0354707 A1
(43) Pub. Date: Dec. 13, 2018

(54) HYDRA PNEUMATIC ACTUATOR FOR BAG-ON-VALVE AND CANISTER-ON-VALVE SYSTEMS

(71) Applicant: Alternative Packaging Solutions, LLC, New York, NY (US)

(72) Inventor: William S. BLAKE, Linwood, NJ (US)

(21) Appl. No.: 15/825,321

(22) Filed: Nov. 29, 2017

Related U.S. Application Data
(63) Continuation-in-part of application No. 15/731,435, filed on Jun. 8, 2017, now abandoned.

(51) Int. Cl. B65D 83/20; B05B 1/30; B65D 83/44; B65D 83/62

(52) U.S. Cl. CPC B65D 83/205; B05B 1/3046; B65D 83/62; B65D 83/207; B65D 83/44

(57) ABSTRACT

An Actuator that facilitates a Hydra Pneumatic Valve while insuring complete evacuation of product by use of a dual MBU (Mechanical Breakup) nozzle area that can be fixed at a preset or variable dispensing mode for application of a half and half mix or a ratio mix of product to air, atomized output. Aside from utilizing 95% of the Preload pressure as part of the effective spray output, the Actuator Outer Body may be ergonomically or aesthetically designed. The present invention will have variations of customization to suit a variety of products that require higher pressures, not being capably achieved with present standard Bag-ON-Valve Systems without having heavier wall containers which adds expense and hazards accordingly.

### CROSS-REFERENCE TO RELATED APPLICATIONS

This application is a continuation-in-part of co-pending U.S. application Ser. No. 15/731,435, filed Jun. 8, 2017.

### BACKGROUND OF INVENTION

### Field of Invention

The present invention relates to a hydra-pneumatic actuator for bag-on-valve and canister-on-valve systems.

### Brief Description of Related Art

The present invention relates to Actuator Assembly Systems required to provide the accommodation and insurance, having the capability to dispense products requiring higher pressures that the current bag-on-valve systems do not accommodate. Such products as Hair Sprays, Oils, Particulate-embedded Anti-Deodorants, other high viscosity products and pumps that have difficulty breaking up. This present invention achieves these abilities by diluting the products with pressurized air. The product being applied to the first MBU atomization stage which is emitted into the pressurized second stage air chamber before it exists the in tandem nozzle. The in tandem MBU is placed as the last means that product becomes in contact with air, unlike pump systems that require venting and current bag-on-valve systems, having to rely on the expanded preloaded charges which initially provide enough pressure but at the end of the preload charge, “Peters Out”. The present invention eliminates these drawbacks without having to use heavier wall containers or vessels which must withstand almost double the preloads now in use, causing higher cost and increasing hazardous conditions. The present invention operates at lower than half the preloads currently used but will provide the outputs of higher pressure aerosols now on the market, at much lower costs of manufacture/assembly currently employed. Also the present invention has an inherent or built in Non Clog Feature. This new means is part of the concept whereas, upon each cycle of dispensing air, is, the first and last to be emitted from the in tandem nozzle which is solely controlled within the valve below it, supplying the Hydra Pneumatic Actuator with the in tandem Nozzle having its own means of emitting a fixed or variable output that can be “Half and Half” or “a Ratio Mix amount” needed, depending on a specific product properties. The present provides the flexibility that does not exist in previous Actuators being used on current systems throughout the industry as it stands.

There are other systems that do not offer the posed advantages of the present invention. The present invention with its new means as disclosed, will indicate differences by way of Examples given below:

U.S. Pat. No. 4,982,900 of Blake discloses a trigger pump sprayer with several nose piece valve configurations;
U.S. Pat. No. 5,110,052 of Graf et al discloses a pump means employing air assist at the nozzle and requires venting;
U.S. Pat. No. 4,057,176 of Horvath discloses a pump means that is similar to Graf et al providing air assist to the nozzle; and
U.S. Pat. No. 9,387,977 of Blake discloses a Hydra Pneumatic Valve means requiring a system such as disclosed, as an advantage in the new present invention.

### BRIEF SUMMARY OF THE INVENTION

It is an object of the present invention to provide a means and method of ease to manufacture.

It is another object of the present invention to provide flexibility in selecting a fixed or variable means that can be dispensed within the Actuator nozzle area.

It is a further object of the present invention is to provide alternative means in selecting more than one Actuator Assembly that offers the equivalent results as provided by way of the same present invention.

It is another object of the present invention to provide a means to equate to what Aerosol Systems at higher pressures emit without having special vessels or containers but, allows same results at lower pressure levels utilizing a lighter walls in vessels or containers. For lower cost but offer advantages overall.

It is a further object of the present invention to provide a means that keeps the product isolated from the air pressure assist path until it is mixed at the exit area of the Actuator Assembly Nozzle from the in tandem MBU's.

The foregoing and other features of the invention are hereinafter more fully described below, the following description setting forth in detail certain illustrative embodiments of the invention, these being indicative, however, of but a few of the various ways in which the principles of the present invention may be employed.

### BRIEF DESCRIPTION OF THE DRAWINGS

With reference to the accompanying drawing figures, please note that:

FIG. 1 Is a cross sectional view of the preferred Actuator Assembly in the OFF mode;

FIG. 1a is a partial top view of FIG. 1;

FIG. 1b is a bottom view of FIG. 1;

FIG. 1c is a Front Left Half side view with Regulator Rack shown closed;

FIG. 2 is cross sectional side view of the Over Body Valve Housing;

FIG. 2a is a Bottom view of FIG. 2;

FIG. 2b is a right half rear view of FIG. 2;

FIG. 3 is a cross sectional side view sub assembly of Product MBU Valve Housing Threaded Regulator Pin Retracted;

FIG. 3a is a bottom view of FIG. 3;

FIG. 3b is a cross sectional side view sub assembly of Product MBU Valve Housing Threaded Regulator Pin Extended;

FIG. 3c is a bottom view of FIG. 3b;

FIG. 3d is a full rear view of FIG. 3;

FIG. 3e is a full rear view of FIG. 3b;

FIG. 4 is a cross sectional side view of Product MBU Valve Housing with threaded rear pocket;

FIG. 4a is a bottom view of FIG. 4;

FIG. 4b is a full rear view of FIG. 4;

FIG. 5 is a cross sectional side view of the Threaded Regulator Pin;

FIG. 5a is a full side view of FIG. 5;

FIG. 5b is a full bottom view of Product MBU Housing with threaded Regulator Pin;

FIG. 6 is a cross sectional side view of the Product MBU Fixed Valve Housing;

FIG. 6a is a bottom view of FIG. 6;

FIG. 6b is a full rear view of FIG. 6;

FIG. 7 is a cross sectional side view of the Fixed Regulator Pin;

FIG. 7a is a full side view of FIG. 7;

FIG. 7b is a bottom view of FIG. 7;

FIG. 7c is a rear view of FIG. 7 showing latches and pockets for the Valve Housing Retainer Flange;

FIG. 8 is a cross sectional side view Assembly of the Alternative Actuator four piece;

FIG. 8a is a full front view of FIG. 8;

FIG. 8b is a front view ISO of FIG. 8;

FIG. 8c is a exploded ISO view of all the parts of FIG. 8;

FIG. 9 is a full side blown out sequence of assembly view of all four parts;

FIG. 9b is a full side view of the Alternative Actuator Body Housing;

FIG. 10 is a bottom view of FIG. 9b turned 180 degrees out of phase;

FIG. 11 is a top view of FIG. 9b;

FIG. 12 is a front view of FIG. 9b;

FIG. 13 is a front ISO view of FIG. 9b;

FIG. 13a is a ISO blown out 3 part view of FIG. 9 without the dressed collar shown;

FIG. 14 is a ISO front oblique view of the MBU Fitment shown in FIG. 15;

FIG. 15 is a blown up full side view of the MBU Fitment of FIGS. 14 and 15;

FIG. 16 is a full side blow up view of the Threaded MBU Regulator Fitment;

FIG. 16a is a Front ISO blown up view of FIG. 16;

FIG. 16b is a Rear view ISO view of FIG. 16;

FIG. 16c is a bottom view of FIG. 16b showing the eyebrow MBU configuration;

FIG. 17 is a cross sectional view of the preferred Actuator Assembly System of FIGS. 1 and 1c as shown in a partially positioned mode over the Valve Assembly in FIG. 18 (The Actuator skirt in the Assembly of FIG. 1 needs dressing off to fully fit properly and to accommodate the full actuation stroke necessary to allow the Actuator Assembly to be fully depressed and properly function; and

FIG. 18 is a cross sectional view of the Valve in FIG. 17 without an Actuator Assembly.

### DETAILED DESCRIPTION OF THE INVENTION

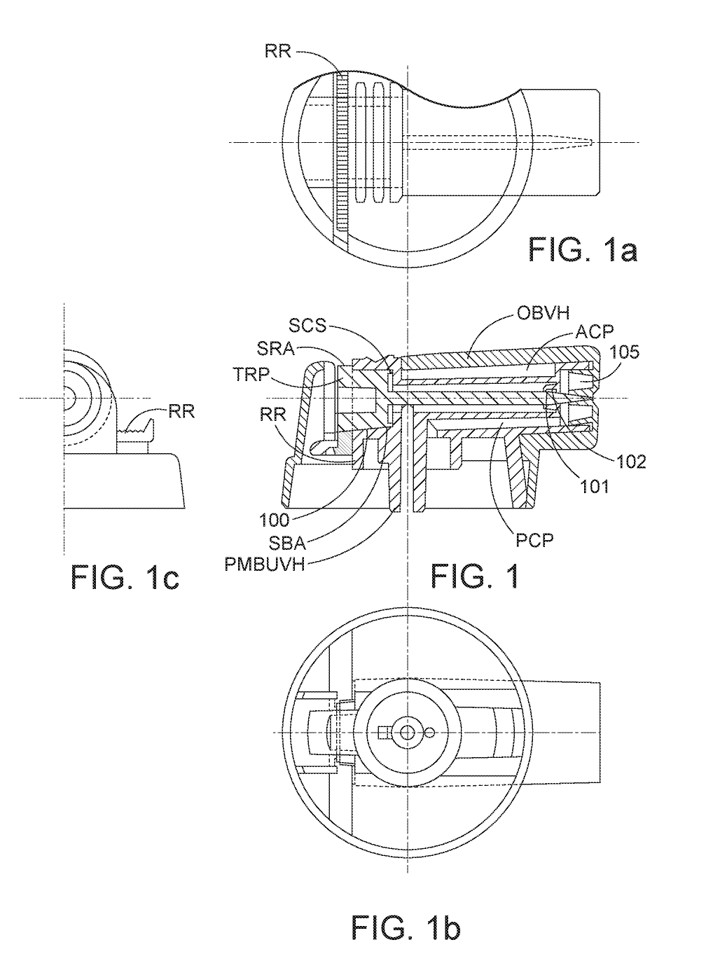

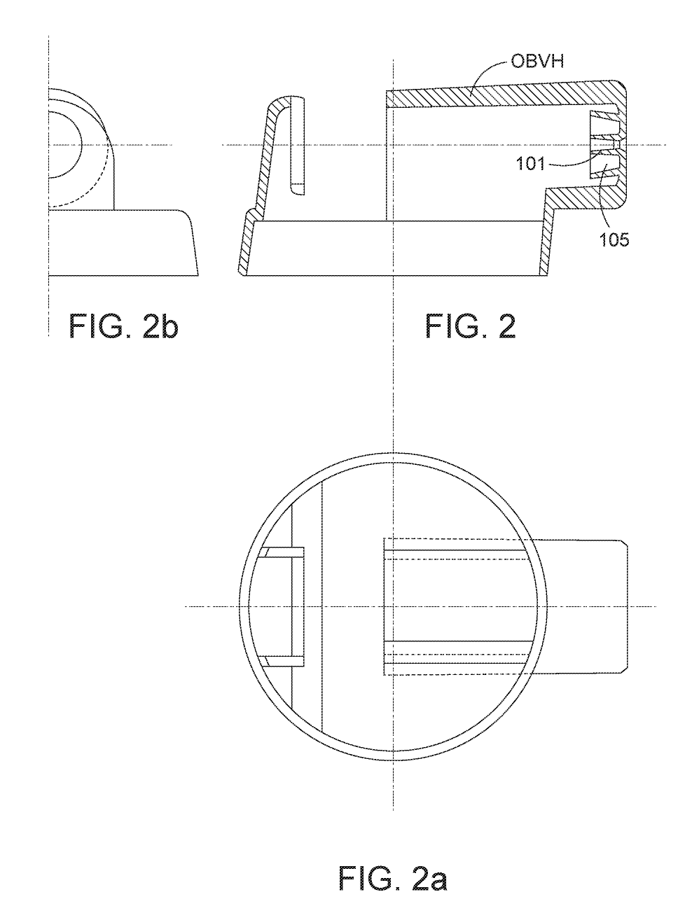

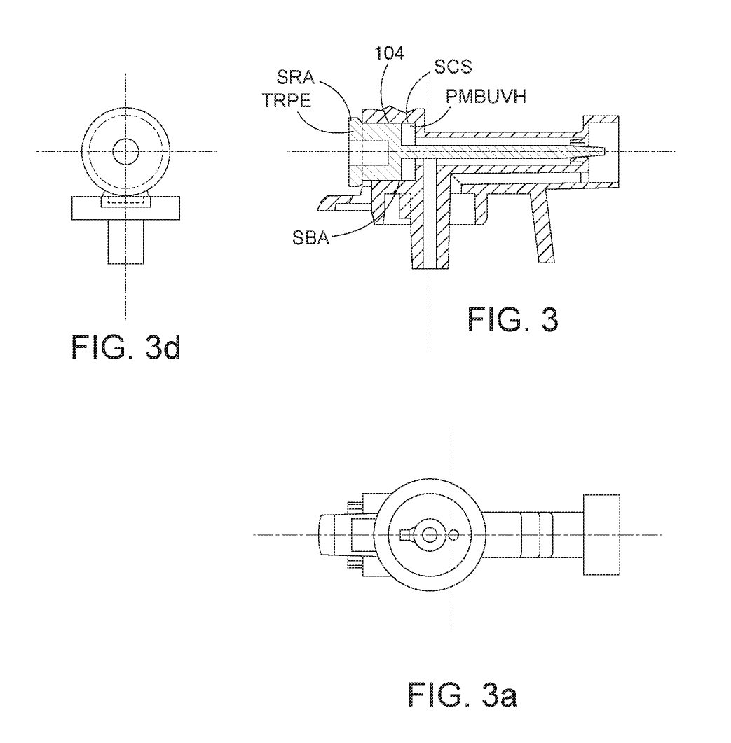

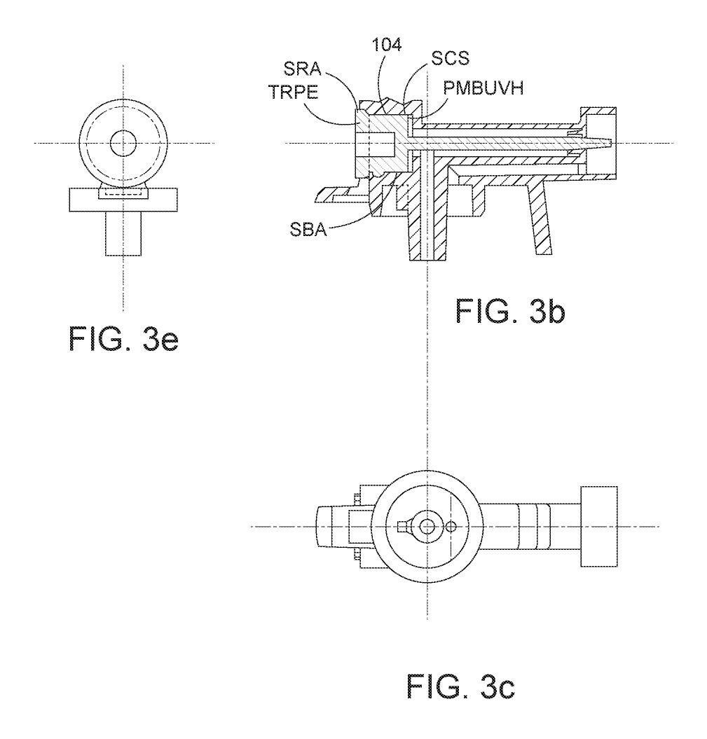

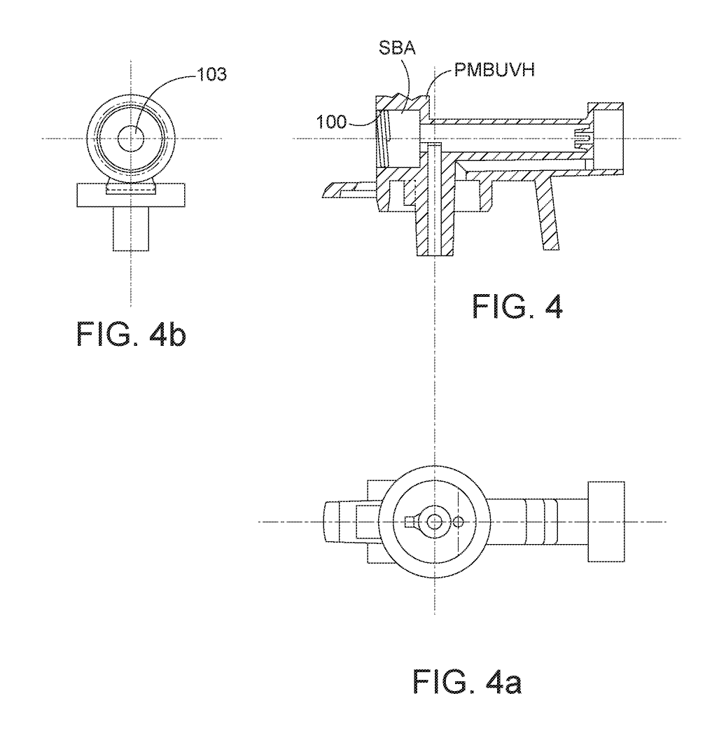

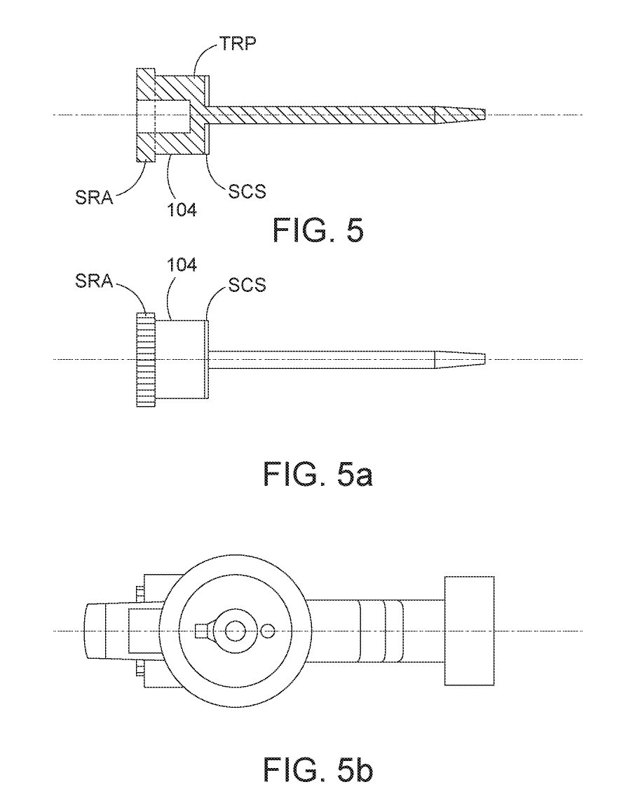

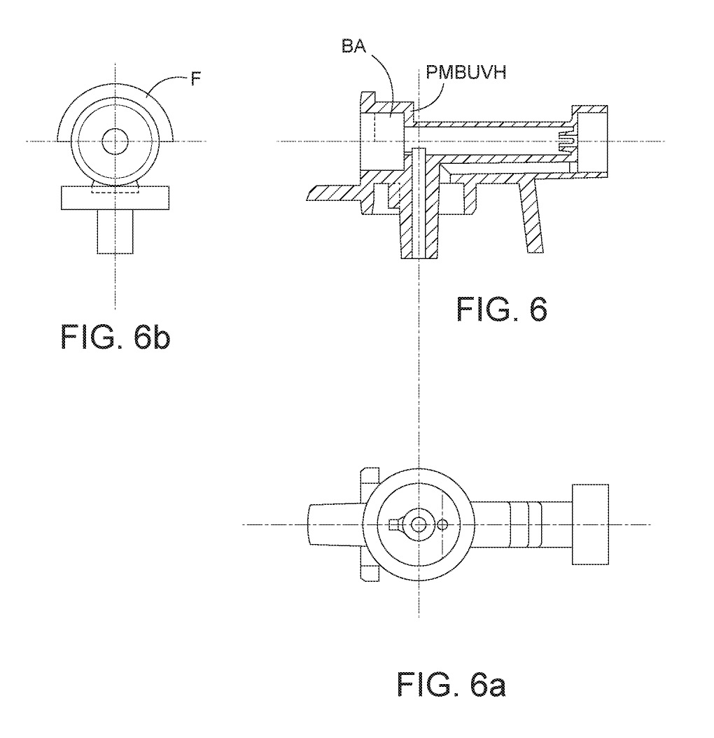

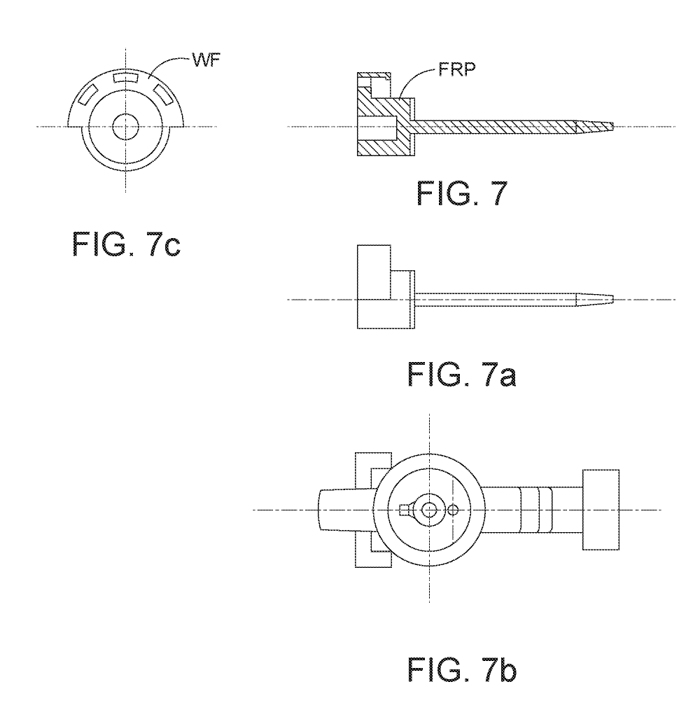

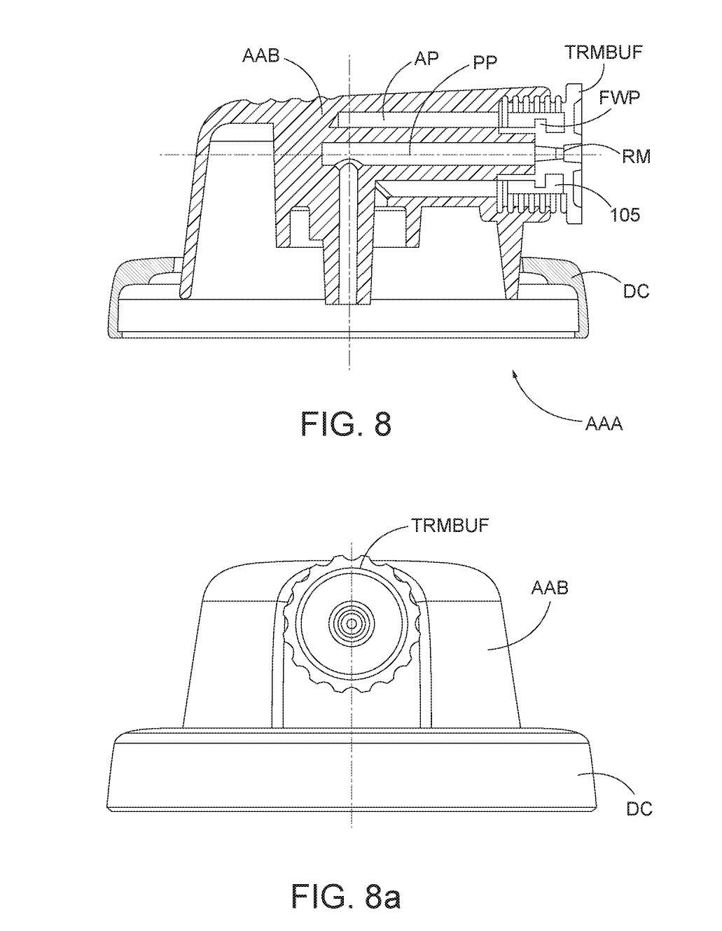

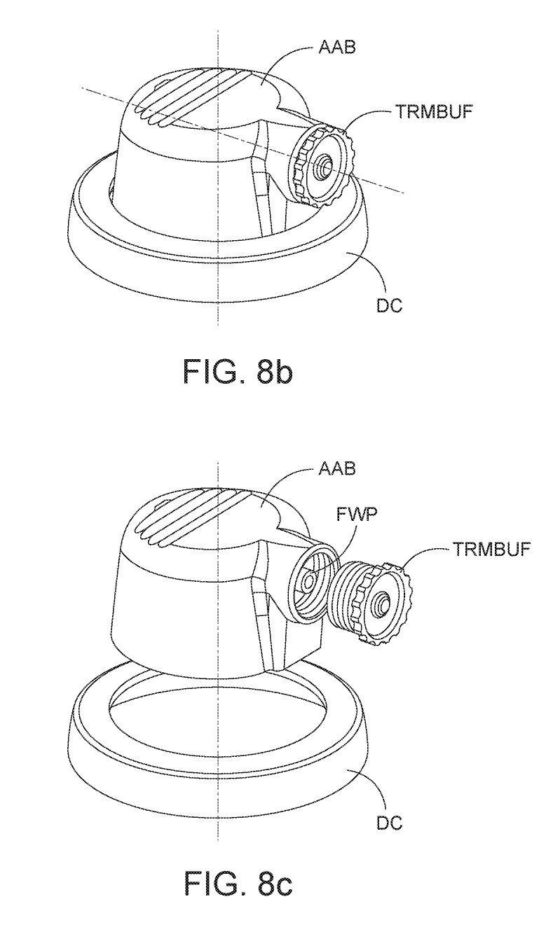

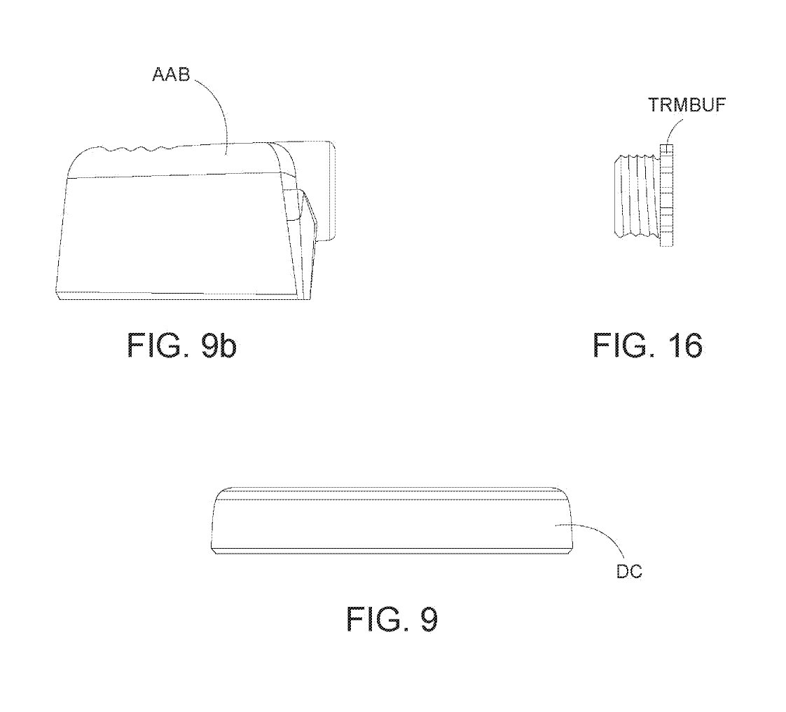

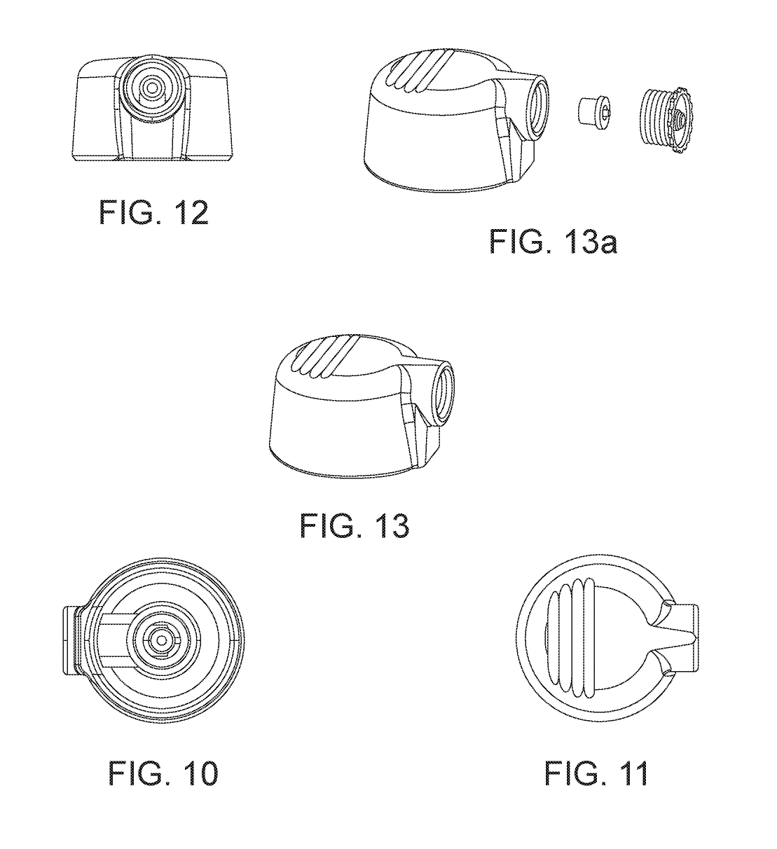

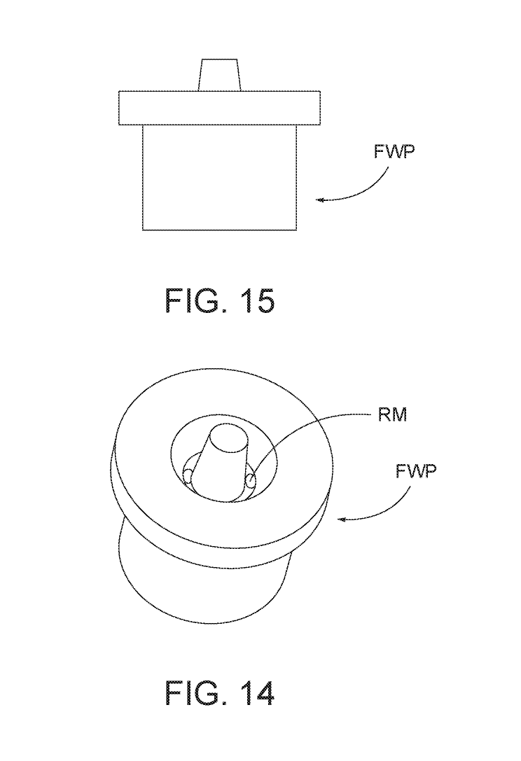

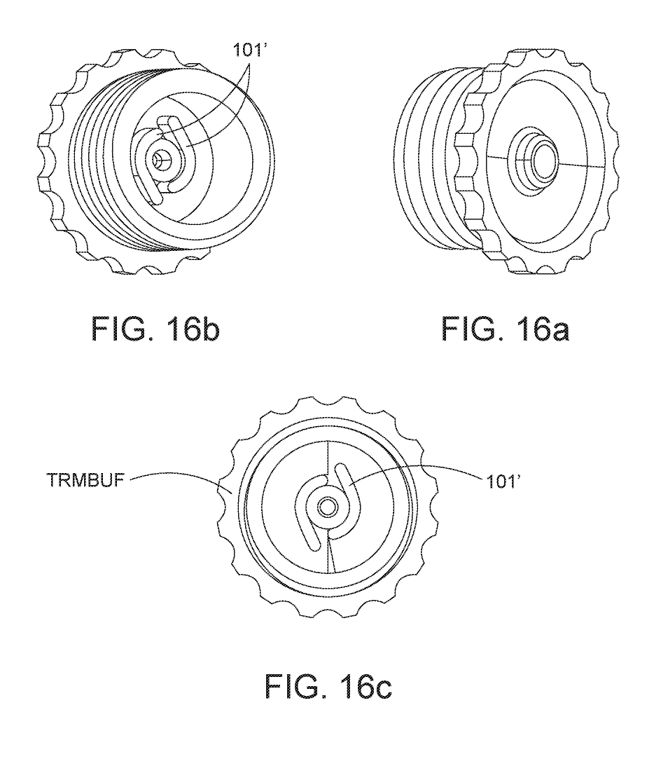

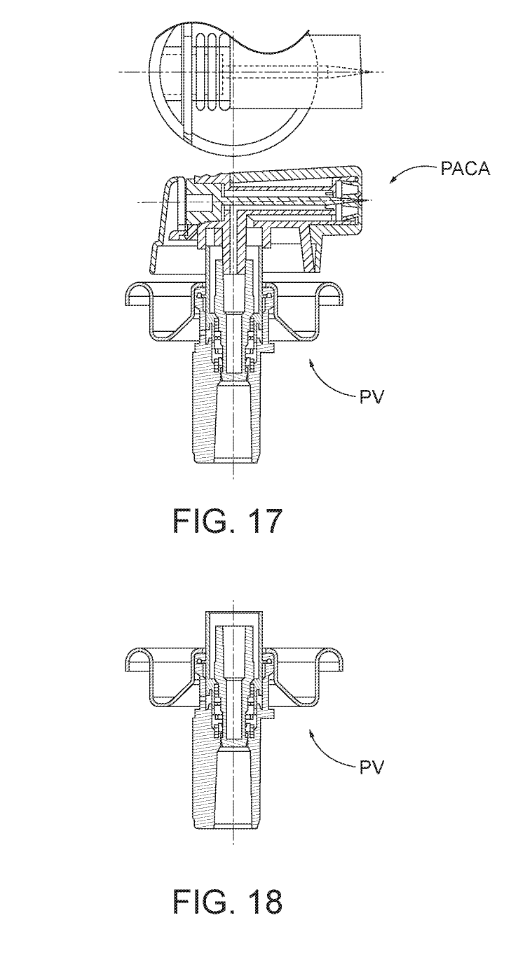

With references FIGS. 1-18, in compliance with the operation of the present invention there is an Actuator Assembly as shown in FIG. 1. Also shown in FIG. 1 is an over body valve housing OBVH with a threaded regulator pin TRP threaded into the rear pocket 100 of the product MBU (Mechanical breakup) valve housing PMBUVH which has a forward internal end with a set of offset eyebrows 101 that surrounds the forward end pin 102 of the threaded regulator pin TRP forming the MBU product vortex chamber 103 see rear view of FIG. 4. Within the Product MBU Valve Housing PMBUVH there includes two feed paths, a product chamber path PCP and an Air Chamber Path ACP. Also within the mechanical means as shown in FIGS. 1, 1a and 1e there is illustrated, a regulator rack RR, engaged with a threaded hub 104 and also at the same end there is a serrated ring area SRA engaged with the serrated upper surface on the regulator rack RR shown in FIGS. 3, 3b, 5 and 5a. On the threaded regulator pin TRP there is a sliding chevron seal SCS that travels within the PMBUVH Sliding Bore Area SBA. The RR, SCS and SBA are shown in FIGS. 1, 1b and 1c, causes right to left or reverse direction turning of the threaded regulator pin TRP in and out of position within the internal MBU pocket eyebrows 101, controlling the vortex product pattern. This pattern is emitted into the air chamber 105 is further atomized in the same matter as within the product chamber to an enhanced spray pattern. The regulator pin TRP may be fixed as shown FIGS. 6, 6a, 7, 7a and 7c by a latch and windowed flange WF within the modified Product MBU Fixed Valve Housing PMBUFVH shown in FIG. 6. The Regulator Pin, whether threaded TRP or fixed FRP controls the outputs by its insertion depths within the product chamber 103 and air chamber 105 in unison. In the fixed mode, the PMBUFH has a TRP with a fixed chevron seal FCS and a bore area BA. As explained and illustrated, there is a means to supply and enhance the product spray pattern for a proper low pressure source valve as shown in FIG. 18, whereas, a presently, patented valve PV shown in FIG. 18 and referenced earlier, will be utilized accordingly, with Actuator Assembly shown in FIGS. 1 and 17. The need for a high pressured vessel is eliminated and a lower pressure vessel which may be plastic or metal and have a variety of shapes can be used. There is another means Alternative Actuator Assembly AAA shown in FIGS. 8 through 16c whereas a three or four piece as in AAA will provide results similar to the previously described embodiment. This concept comprised of an Alternative Actuator Body AAB, which houses a fitment with a pin FWP and a threaded regulator fitment TRMBUF. This assembly will also utilize the same valve illustrated in FIG. 18. The valve PV supplies the air and product to AAA. There is a dual path delivery of product PP and air AP as shown in FIG. 8. The product is fed to a fitment with pin FWP and restricting means RM of at least two holes located within the wall supporting the pin that together with offset eyebrows 101′ as shown in FIGS. 16b and 16c. 101′ surrounds the pin surface, to vortex the Air supply similar to the prescribed construction of FIG. 1, and is emitted from air chamber 105′ within the threaded MBU regulator fitment TRMBUF. A mixed vortex output may be adjusted via the turning in and out of TRMBUF. In addition a dress collar DC may be an option and can be reconstructed creating a spray through over cap concept not shown.

With the Actuator Assemblies described above, as demonstrated and explained, the preferred and alternative embodiment(s) will enhance spray performance over a wide range of product viscosities without having restraints on these pressurized systems. The present invention is a “GREEN” system. Bag-On-Valve or Canister-On-Valve systems currently on the market cannot handle products that demand higher pressures without having to utilize heavier wall vessels that are an additional cost to the package and borders on hazards to the environment. There is an attached listing of reference characters with abbreviations for the parts described in the detailed description of the invention.

For Example: A system in compliance shown below would be as described below:

A 400 ml Container with a 6 oz. (Approx. 180 ml) Product Bag or Cylinder fill, and an Air preload of 45 psi (3 bar) utilizing either Actuator Assembly above adjusted to deliver a 50/50 (Product to Air) mix and a spray rate of 1 ml per second, will insure a fully evacuated product with abundant Air to spare.

Accordingly, resort may be made to all suitable modifications and equivalents that fall within the scope of the present invention as defined by the claims which follow. The words “comprise”, “comprising”, “include(s)”, and “including” when used in this specification and in the following claims are intended to specify the presence of stated feature or steps, but they do not preclude the presence or addition of one or more other features or means, steps or groups thereof.

The following reference characters are used in the drawing figures (abbreviated listing):
AAA Alternative Actuator Assembly;
PACA Preferred Actuator Composite Assembly;
PV Patented Valve;
RR Regulator Rack;
OBVH Over Body Valve Housing;
TRPR Threaded Regulator Pin Retracted;
PMBUVH Product MBU Valve Housing;
TRPE Threaded Regulator Pin Extended;
TRP Threaded Regulator Pin;
PMBUFVH Product MBU Fixed Valve Housing;
F Flange;
FRP Fixed Regulator Pin;
FWP Fitment With Pin;
WF Windowed Flange;
AAB Alternative Actuator Body;
TRMBUF Threaded Regulator MBU Fitment;
DC Dress Collar;
PCP Product Chamber Path;
ACP Air Chamber Path;
SRA Serrated Ring Area;
SBA Sliding Bore Area;
SCS Sliding Chevron Seal;
FCS Fixed Chevron Seal;
BA Bore Area; and
RM Restricting Means.

Additional advantages and modifications will readily occur to those skilled in the art. Therefore, the invention in its broader aspects is not limited to the specific details and illustrative examples shown and described herein. Accordingly, various modifications may be made without departing from the spirit or scope of the general inventive concept as defined by the appended claims and their equivalents.

What is claimed is:

1. An Actuator Assembly for usage with a Hydra Pneumatic Valve comprising three or four parts, whereas there is an Over Body Housing with a mechanical breakup means comprising of a set of offset eyebrows within the forward end of said housing and an open end pocket and wall with retainer means, whereas there is a another inner body that is received by the said Over Body Housing having dual feed paths in tandem which are internally and separately apart with one being the product feed path and the other being the air feed path and both are in separate communication within a coaxial concentric pair of extended cylindrical walls said dual paths are fed into two chambers the first is at the forward end of the said Over Body Housing and second is at the end of the inner body having a duplicate pairs of offset eyebrows which are in axial communication, whereas a threaded regulator pin controls the product and air feed mix creating the desired spray pattern by extending and retracting said pin within the dual pair of eyebrows to form the required spray output comprising of the combined inner action between both sets of eyebrows and regulator pin which can be a range of a ratio mix.

2. The assembly of claim 1, wherein said inner body having a threaded pocket area to accept said a threaded regulator pin.

3. The assembly of claim 1, wherein a serrated slide rack is engaged with a serrated ring at the rear end of the regulator pin said rack has a fitted slide retention pocket means within a portion area extending out from the inner body housing which is engaged and retained in its proper positioning by the over body housing assembly.

4. The assembly of claim 1, wherein said regulator pin that is without threads and is at a fixed position within a pocket retention means within the inner body having a retention bead or retention means within the same area complimenting the product to air mix output.

5. The assembly of claim 1, wherein the said over body housing having within its forward pocket a cylindrical seal bead that is accepted within a bore seal area within the inner body at its end together forming a air seal.

6. An Actuator Assembly for usage with a Hydra Pneumatic Valve comprising of three or four parts, whereas a body housing has an internally cylindrical horizontal projection extending outwardly from a vertically aligned coaxial concentric pair of extended cylindrical walls having received within the horizontal projection a fitment with pin and also within an outer horizontal extension is a air path leading to a internally threaded nose area receiving a threaded mechanical breakup fitment having a pair of offsetting eyebrows surrounding said pin that causes an air vortex impacting the product received from the product path which is in the internally cylindrical horizontal projection leading to the backside of the fitment with pin being separated by a cylindrical retaining wall with a flanged edge stop wall having more than one or more feed holes through it and into a surrounding recessed moat at the base of the pin to be subjected to a vortex area where the air is combined with the product before it exits the nozzle orifice.

7. The Actuator Assembly of claim 6, wherein the threaded regulator mechanical fitment there is a serrated flange for adjusting the ratio of air to product mix whereas product from a separate path and the air from a separate path is applied to be atomized via the said moat in combination with the fitment pin and offset eyebrows in the threaded regulator forming an adjustable mechanical breakup means for producing a wide variety of spray patterns.

8. A fitment with pin having a cylindrical retention wall with a stop flange wall support and on its face a projected pin that at its base has a recessed moat surrounding it and within the moat a controlled pattern of a hole size feeds for receiving the product to be further atomized via the air vortex means.

9. The Actuator Assembly of claim 6, wherein a dress collar can be customized to facilitate a spray through over cap system.

10. An apparatus that supports a dual path Valve System as claimed in claim

11. A method for a dispensing means that can ratio a combination of product and air for a variety of viscosities needed in categories requiring higher pressures but at lower pressures being used as claimed in claim 1 that are produced by Dual Path Valves.

12. The apparatus and method as in claim 11 that provides the ability to utilize lighter and shaped containers more economically without jeopardizing overall packaging economics.

13. The Actuator Assembly as claimed in claim 1 that accommodates the dispensing of products at all angles.
